(19) United States
(12) Patent Application Publication
(10) Pub. No.: US 2011/0298763 A1
(43) Pub. Date: Dec. 8, 2011

(54) NEIGHBORHOOD BRIGHTNESS MATCHING FOR UNIFORMITY IN A TILED DISPLAY SCREEN

(76) Inventor: Amit MAHAJAN, Bangalore (IN)

(21) Appl. No.: 12/980,611

(22) Filed: Dec. 29, 2010

(30) Foreign Application Priority Data
Jun. 7, 2010 (IN) 1318/DEL/2010

(51) Int. Cl. G09G 5/10; G09G 5/00

(52) U.S. Cl. 345/207; 345/690; 345/1.3

(57) ABSTRACT

Brightness between the individual tiles of a tiled display system is matched for improved uniformity and overall brightness of images produced by the display system. Regions of the display system adjacent to a tile with low brightness performance are incremented in brightness from the brightness level of the low brightness tile to the brightness level of higher brightness tiles. By incrementing the brightness of such regions according to embodiments of the invention, perceived brightness uniformity of images produced by the tiled display system is maintained while maximizing the overall brightness of the display device. The regions used to increment brightness may be as large as an entire tile or as small as a single pixel element.

### BACKGROUND OF THE INVENTION

1. Field of the Invention

Embodiments of the present invention generally relate to tiled display screens, and more specifically, to systems and methods of brightness matching for improved uniformity and brightness of such display screens.

2. Description of the Related Art

Electronic display systems are commonly used to display information from computers and other sources. Typical display systems range in size from small displays used in mobile devices to very large displays, such as tiled displays, that are used to display images to thousands of viewers at one time. Tiled display systems are generally made up of multiple smaller individual display devices, or “tiles”, that are carefully aligned when assembled to provide a seamless and uniform appearance.

Because the human eye can readily perceive small differences in brightness uniformity of a displayed image, the use of multiple display devices in a tiled display system can produce visual artifacts in an image when the output of one or more of the individual tiles is not closely matched to the brightness of adjacent tiles. For example, differences in brightness between adjacent display devices in a tiled display can be as small as a few percent and still be apparent to a viewer. Consequently, the color matching and brightness of the individual tiles making up a tiled display system must be closely matched to avoid a non-uniform appearance. To that end, color generation and brightness of the individual tiles are typically matched in a factory calibration procedure or during the initial setup of the tiled display device to minimize brightness nonuniformity therebetween.

However, because the brightness of individual tiles may degrade over time, for example due to changes in light source performance, initial calibration cannot prevent brightness nonuniformity of a tiled display system throughout the life of the system. Instead, as one or more tiles suffer from reduced brightness, all other tiles in the display system can be dimmed to match the brightness of the worst-performing tile in the display. What results is a display image with brightness uniformity, but one that is noticeably dimmer.

### SUMMARY OF THE INVENTION

One or more embodiments of the invention provide systems and methods for brightness matching between the individual tiles of a tiled display system for improved uniformity and overall brightness of images produced by the display system. Regions of the display system adjacent to a tile with low brightness performance are incremented in brightness from the brightness level of the low brightness tile to the brightness level of the higher brightness tiles. By incrementing the brightness of such regions according to embodiments of the invention, perceived brightness uniformity of images produced by the display system is maintained while maximizing the overall brightness of the tiled display device. The regions used to increment brightness may be as large as an entire tile or as small as a single pixel element.

One embodiment of the invention provides a tiled display system comprising a first display tile having a luminance detector, a second display tile adjacent to the first display tile, and a control unit configured to receive luminance information from the luminance detector and, when the luminance information indicates that a brightness level of the first display tile is below a threshold level, determine a new brightness setting for the second display tile that correlates to a new brightness level that is greater than the brightness level of the first display tile.

Another embodiment of the invention provides a tiled display system comprising a first display tile, a second display tile adjacent to the first display tile, and a control unit configured to control brightness levels of pixels of the second display tile based on their proximity to the first display tile in response to a threshold decrease in a brightness level of the first display tile.

A further embodiment of the invention provides a method of controlling brightness levels of a tiled display system that includes a first display tile and a second display tile that is adjacent to the first display tile, the method comprising measuring a luminance level of the first display tile, determining that the brightness level of the first display tile is below a threshold level, and adjusting a brightness level of the second display tile in response to said determining.

A further embodiment of the invention provides a computer-readable storage medium comprising instructions to be executed by a computing device to cause the computing device to carry out the steps of receiving a luminance level of a first display tile, determining that the brightness level of the first display tile is below a threshold level, and reducing a brightness level of a second display tile that is adjacent to the first display tile in response to said determining, wherein the brightness level of the second display tile is reduced and a new brightness level of the second display tile after the reduction is greater than the brightness level of the first display tile.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a perspective schematic diagram of a tiled display system that may benefit from embodiments of the invention.

FIG. 2 is a schematic diagram of a display tile that may be used as a tile of a tiled display system.

FIG. 3 is a partial schematic diagram of the portion of a fluorescent screen indicated in FIG. 2.

FIG. 4 is a schematic diagram of a display screen using “tilewise” neighborhood brightness matching, according to embodiments of the invention.

FIG. 5 is a schematic diagram of a tile with a plurality of colorimeter test regions, according to embodiments of the invention.

FIG. 6 is a partial schematic diagram illustrating the relative brightness of a region of a low-brightness tile and an adjacent tile that has undergone tilewise neighborhood brightness matching, according to embodiments of the invention.

FIG. 7 is a flow chart that summarizes, in a stepwise fashion, a method for performing neighborhood brightness matching in a tiled display system, according to embodiments of the invention.

FIG. 8 is a schematic diagram of a tile having a plurality of display units that illustrates intra-tile neighborhood brightness matching, according to embodiments of the invention.

For clarity, identical reference numbers have been used, where applicable, to designate identical elements that are common between figures. It is contemplated that features of one embodiment may be incorporated in other embodiments without further recitation.

### DETAILED DESCRIPTION

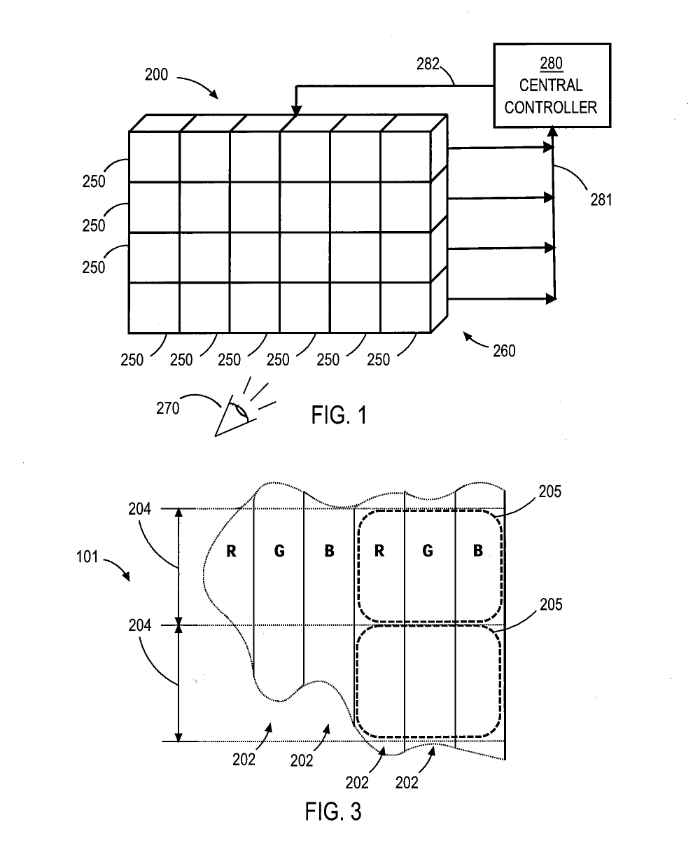

FIG. 1 is a perspective schematic diagram of a tiled display system 200 that may benefit from embodiments of the invention. Tiled display system 200 comprises a plurality of tiles 250, which are positioned to form a single display screen 260 for a viewer 270. Each of tiles 250 is a light-based electronic display device, such as a laser-phosphor display (LPD), a light-emitting diode (LED) digital light processing (DLP), or an LED-liquid crystal display (LCD) device, and is configured to operate in conjunction with the other tiles 250 to produce a single coherent image for viewer 270. Each of tiles 250 also includes a luminance detector (not shown in FIG. 1 for clarity) for dynamically monitoring the output intensity of the light source or light sources in the tile 250. Luminance is a photometric measure of the luminous intensity per unit area of light traveling in a given direction. Tiled display system 200 includes a central controller 280 configured to receive luminance data 281 from the luminance detector of each tile 250, determine suitable luminance settings for each tile 250 according to embodiments of the invention, and provide output signals 282 to tiles 250. Because output signals 282 implement neighborhood brightness matching adjacent to low brightness tiles, brightness gradients across screen 260 between normally performing tiles and low brightness tiles are substantially imperceptible to viewer 270.

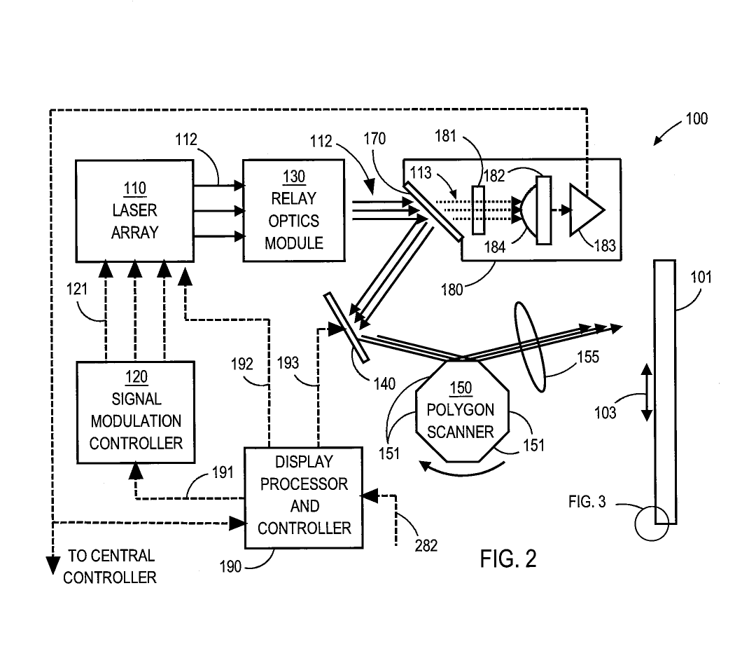

FIG. 2 is a schematic diagram of a display tile 100 that may be used as a tile 250 of tiled display system 200. Display tile 100 is an LPD that uses multiple lasers for illuminating individual pixels of a fluorescent screen 101, and is configured with a luminance detector, i.e., detector assembly 180, for directly measuring output intensity of the multiple lasers during normal operation. Display tile 100 includes fluorescent screen 101, a signal modulation controller 120, a laser array 110, a relay optics module 130, a mirror 140, a polygon scanner 150, an imaging lens 155, a beam splitter 170, a detector assembly 180, and a display processor and controller 190, configured as shown.

Fluorescent screen 101 includes a plurality of phosphor regions or stripes and in one embodiment made up of alternating phosphor stripes of different colors, e.g., red, green, and blue, where the colors are selected so that in combination they can convey white light as well as other colors of light. FIG. 3 is a partial schematic diagram of the portion of fluorescent screen 101 indicated in FIG. 2. FIG. 3 illustrates pixel elements 205, each including a portion of three different-colored phosphor stripes 202. By way of example, in FIG. 3 phosphor stripes 202 are depicted as red, green, and blue phosphor stripes, denoted R, G, and B, respectively. The portion of the phosphor stripes 202 that belong to a particular pixel element 205 is defined by the laser scanning paths 204, as shown. An image is formed on fluorescent screen 101 by directing laser beams 112 (shown in FIG. 2) along the laser scanning paths 204 and modulating the output intensity of laser beams 112 to deliver a desired amount of optical energy to each of the red, green, and/or blue phosphor stripes 202 found within each pixel element 205. Each image pixel element 205 outputs light for forming a desired image by the emission of visible light created by the selective laser excitation of each phosphor-containing stripe in a given pixel element 205. Thus, modulation of the optical energy applied to red, green, and blue portions of each pixel element 205 by the lasers controls the composite color and image intensity at each image pixel element 205.

In the embodiment illustrated in FIG. 3, one dimension of the pixel element is defined by the width of the three phosphor stripes 202, and the orthogonal dimension of the pixel element is defined by the laser beam spot size, i.e., the height of laser scanning paths 204. In other implementations, both dimensions of image pixel element 205 may be defined by physical boundaries, such as separation of phosphor stripes 202 into rectangular phosphor-containing regions. In one embodiment, each of phosphor stripes 202 is spaced at about a 500 μm to about 550 μm pitch, so that the width of pixel element 205 is on the order of about 1500 μm.

Referring to FIG. 2, laser array 110 includes multiple lasers, e.g., 5, 10, 20, or more, and generates multiple laser beams 112 to simultaneously scan fluorescent screen 101. Laser beams 112 are modulated light beams that are scanned across fluorescent screen 101 along two orthogonal directions, e.g., horizontally and vertically, in a raster scanning pattern to produce an image on fluorescent screen 101, which is a portion of the image produced by tiled display system 200. In one embodiment, the lasers in laser array 110 are imaging ultraviolet (UV) lasers producing light with a wavelength between about 400 nm and 450 nm. Over the lifetime of such lasers, output performance may degrade unevenly, causing the overall screen brightness of display tile 100 to decrease relative to the other display tiles making up tiled display system 200. For example, when a single laser in laser array 110 degrades in performance, the other lasers laser array 110 may all be reduced in output intensity to maintain a uniform appearance for display tile 100, which causes display tile 100 to be dimmer than neighboring display tiles in tiled display system 200.

Signal modulation controller 120 controls and modulates the lasers in laser array 110 so that laser beams 112 are modulated at the appropriate output intensity to produce a desired energy to impinge on the fluorescent screen 101. Signal modulation controller 120 may include a digital image processor that generates laser modulation signals 121. Laser modulation signals 121 include the three different color channels and are applied to modulate the lasers in laser array 110. In some embodiments, the output intensity of the lasers is modulated by varying the input current or input power to the laser diodes. In some embodiments, the modulation of laser beams 112 may include pulse modulation techniques to produce desired gray-scales in each color, a proper color combination in each pixel, and a desired image brightness.

Together, relay optics module 130, mirror 140, polygon scanner 150, and imaging lens 155 direct laser beams 112 to fluorescent screen 101 and scan laser beams 112 horizontally and vertically across fluorescent screen 101 in a raster-scanning pattern to produce an image. For the sake of description, “horizontal” with respect to fluorescent screen 101 in FIG. 2 is defined as parallel to arrow 103 and “vertical” with respect to fluorescent screen 101 is defined as perpendicular to the plane of the page. Relay optics module 130 is disposed in the optical path of laser beams 112 and is configured to shape laser beams 112 to a desired spot shape and to direct laser beams 112 into a closely spaced bundle of somewhat parallel beams. Beam splitter 170 is a partially reflective mirror or other beam-splitting optic, and directs the majority of the optical energy, e.g., 99%, of laser beams 112 to mirror 140 while allowing the remainder of said optical energy, i.e., sample beams 113, to enter detector assembly 180 for measurement. The organization and operation of detector assembly 180 is described below. Mirror 140 is a reflecting optic that can be quickly and precisely rotated to a desired orientation, such as a galvanometer mirror, a microelectromechanical system (MEMS) mirror, etc. Mirror 140 directs laser beams 112 from beam splitter 170 to polygon scanner 150, where the orientation of mirror 140 partly determines the vertical positioning of laser beams 112 on fluorescent screen 101. Polygon scanner 150 is a rotating, multi-faceted optical element having a plurality of reflective surfaces 151, e.g., 5 to 10, and directs laser beams 112 through imaging lens 155 to fluorescent screen 101. The rotation of polygon scanner 150 sweeps laser beams 112 horizontally across the surface of fluorescent screen 101 and further defines the vertical positioning of laser beams 112 on fluorescent screen 101. Imaging lens 155 is designed to direct each of laser beams 112 onto the closely spaced pixel elements 205 on fluorescent screen 101. In operation, the positioning of mirror 140 and the rotation of polygon scanner 150 horizontally and vertically scan laser beams 112 across fluorescent screen 101 so that all of pixel elements 205 are illuminated as desired.

Display processor and controller 190 are configured to perform control functions for and otherwise manage operation of display tile 100. Such functions include receiving image data of an image to be generated from central controller 280, providing an image data signal 191 to signal modulation controller 120, providing laser control signals 192 to laser array 110, producing scanning control signals 193 for controlling and synchronizing polygon scanner 150 and mirror 140, and performing calibration functions according to embodiments of the invention described herein. Thus, display processor and controller 190 is configured to individually modulate power applied to each laser in laser array 110 in order to adjust the output intensity of each light source. In addition, when provided with output signals 282 that include neighborhood brightness matching information, display processor and controller 190 is configured to dim the pixel elements 205 of fluorescent screen 101 according to suitable brightness gradients contained in output signals 282, or to dim the pixel elements 205 across fluorescent screen 101 uniformly, according to embodiments of the invention.

Display processor and controller 190 may include one or more suitably configured processors, including a central processing unit (CPU), a graphics processing unit (GPU), a field-programmable gate array (FPGA), an integrated circuit (IC), an application-specific integrated circuit (ASIC), or a system-on-a-chip (SOC), among others, and is configured to execute software applications as required for the proper operation of display tile 100. Display processor and controller 190 may also include one or more input/output (I/O) devices and any suitably configured memory for storing instructions for controlling normal and calibration operations, according to embodiments of the invention. Suitable memory includes a random access memory (RAM) module, a read-only memory (ROM) module, a hard disk, and/or a flash memory device, among others.

Detector assembly 180 is configured to measure the actual output intensity of the lasers in laser array 110 during operation of display tile 100 and, according to some embodiments, includes a neutral-density filter 181, a detector 182, and a current-to-voltage converter circuit 183. By directly measuring the optical energy contained in each of sample beams 113 while display tile 100 is in operation, drift in laser performance can be immediately detected and communicated to central controller 280, so that the brightness of display tile 100 can be determined and adjacent tiles in tiled display system 200 can be dimmed and a more uniform image can be generated by tiled display system 200. To prevent stray or otherwise unwanted light from being measured by detector 182, neutral density filter is configured to stop all wavelengths of light that fall outside of the operating band of sample beams 113. Detector 182 is a conventional light detector, such as a standard silicon photodetector, and may be configured with a collecting dome 184 as shown to direct each of sample beams 113 to a central region of detector 182, since sample beams 113 may not be following identical optical paths when entering detector assembly 180 and may require additional optical manipulation to ensure incidence on the active portion of detector 182. Because the response to incident light of detector 182 may vary at different locations on its surface, detector assembly 180 may include optical steering elements in additional to collecting dome 184 that can more precisely direct each of sample beams 113 to substantially the same point on the surface of detector 182. Current-to-voltage converter circuit 183 is configured to convert the signal produced by detector 182, which is an electrical current, to a voltage signal, for ease of measurement. In operation, light from one laser in laser array 110 enters detector assembly 180 through beam splitter 170, passes through and is conditioned by neutral-density filter 181, is directed to a point near the center of the surface of detector 182, and is measured by detector 182. The voltage signal produced by current-to-voltage converter circuit 183, which is a voltage signal proportional to the optical intensity of light incident on detector 182, is provided to display processor and controller 190 so that the power input to a laser being measured can be adjusted accordingly. As shown, the voltage signal produced by current-to-voltage converter circuit 183 is also directed to central controller 280.

In some embodiments of the invention, a display system may have a different light engine and/or display screen than a LPD. Laser imaging, light-emitting diode (LED) digital light processing (DLP), and LED-liquid crystal display (LCD) systems may also be configured to calibrate and adjust the output of multiple light sources of the display device to produce a more uniform image with the display device.

Tiled display system 200 uses neighborhood brightness matching to produce an image with the same perceived brightness uniformity as a prior art tiled display system, while simultaneously maximizing overall brightness of the display device. Specifically, regions that are adjacent to a tile with low brightness performance, referred to herein as “display units,” are incremented in brightness between the brightness level of the low brightness tile and the brightness level of higher brightness tiles. The display units used to increment brightness in this way may be as large as an entire tile 250 or as small as a single pixel element 205.

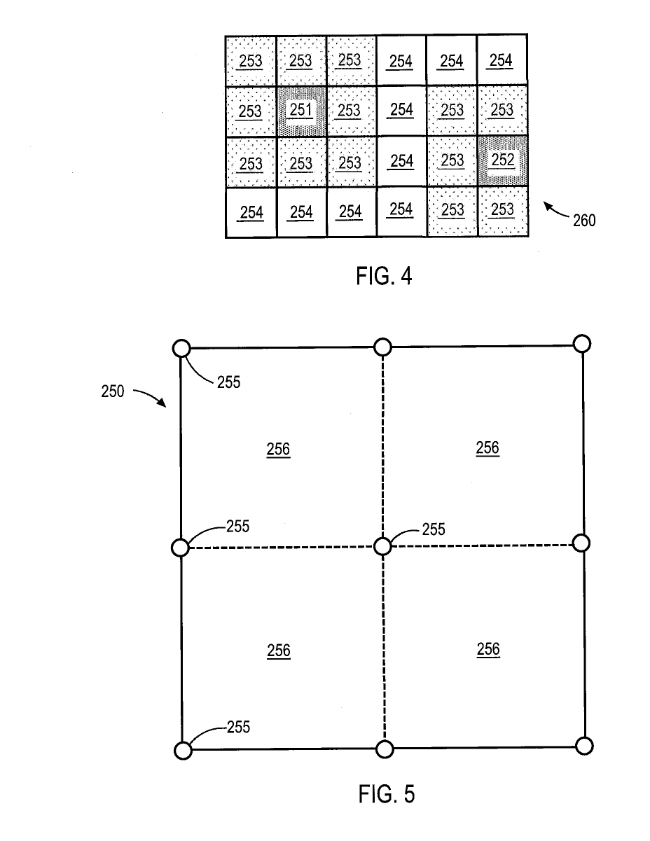

FIG. 4 is a schematic diagram of display screen 260 using “tilewise” neighborhood brightness matching, according to embodiments of the invention. In a tilewise neighborhood brightness matching scheme, the display units used to increment brightness across display screen 260 are tiles 250. In FIG. 4, the brightness of each tile 250 is represented qualitatively by shading, where heavier shading indicates lower brightness and no shading indicates that a tile has normal, unreduced brightness. Low-brightness tiles 251, 252 are display tiles having significantly degraded brightness performance, as indicated by the darker shading. Reducing the brightness of all other tiles 250 to match the reduced brightness of low-brightness tiles 251, 252 would maintain absolute brightness uniformity across display screen 260 but would significantly reduce overall brightness of display screen 260. Instead, all tiles adjacent to low-brightness tiles 251, 252, i.e., tiles 253, are incremented in brightness to be slightly but imperceptibly brighter than low-brightness tiles 251, 252. Tiles 253 also include tiles sharing a common corner with low-brightness tiles 251, 252. Similarly, all tiles adjacent to or sharing a common corner with tiles 253, i.e., tiles 254, are further incremented in brightness to be slightly but imperceptibly brighter than tiles 253. In this way, the overall brightness of display screen 260 can be maximized while maintaining perceived brightness uniformity for viewer 270.

Tilewise neighborhood brightness matching, as illustrated in FIG. 4, is a computationally efficient procedure, since the number of display units is relatively small and the calculation of how much and where the dimming is implemented is not particularly intensive. Dimming calculations for each tile 250 are simplified in tilewise neighborhood brightness matching since there is no need to manipulate input values to the pixel elements 205 of a tile 250 with respect to gamma correction, since the brightness of the entire tile 250 is dimmed uniformly. In addition, calculation of the brightness of each tile is relatively simple since tile brightness may be considered to be proportional to the output intensity of the light sources for the tile, e.g., the lasers in laser array 110. Specifically, output intensity of the light sources of the tile are multiplied by a brightness factor for that tile that may be determined in a factory calibration procedure using a tristimulus colorimeter (an example of such a tile brightness factor calculation is described below in conjunction with FIG. 5). The brightness gradients across screen 260 that can be achieved using tilewise brightness matching are limited, however. Since contrast sensitivity of the human eye is a function of display unit size, the maximum allowable brightness gradient per tile that can be realized is relatively small, e.g., on the order of 1 or 2% per tile, when display units are as large as a typical tile 250, which may be on the order of 500 mm×500 mm in size, or even larger, such as 25 inches diagonal. Exemplary calculations of maximum allowable brightness are described below in conjunction with Equations 1-3.

Calculation of a maximum allowable brightness gradient, g, is now described, according to some embodiments of the invention. Given that D is the maximum viewing distance of tiled display system 200, e is human eye tolerance of variation in brightness per degree of arc, which is approximately 10%, and m is the number of cycles of contrast per degree at which maximum contrast sensitivity occurs in the human eye, it follows that in (1/m)th of a degree of arc, the human eye has brightness tolerance of (e/m) %, and that in smaller than (1/m)th of a degree of arc, the brightness will be averaged out by the human eye. A threshold width W may be defined as minimum width over which the human eye averages out the brightness for a region, where maximum brightness variation is (e/m) %. Threshold width W is thus defined by Equation 1:

$$W = \frac{π * D}{m * 180} \qquad ( 1 )$$

Maximum allowable brightness gradient, g is calculated using either Equation 2 or Equation 3, below. When the distance between two display units w is greater than W, g is calculated with Equation 2:

$$g = \frac{e}{m} \qquad ( 2 )$$

where e is human eye tolerance of variation in brightness per degree of arc, which is approximately 10%, and g is expressed in % of brightness change per display unit. For essentially all practical applications of “tilewise” neighborhood brightness matching, i.e., when a display unit is a tile, g is calculated using Equation 2. Thus, when a display unit is a tile 250, g=1.25% per tile. With such a small maximum allowable brightness gradient, the most increase in brightness across the width of tiled display system 200 that can be achieved without perceptible nonuniformity is only a few percent. However, when the distance between two display units w is less than threshold width W, g is calculated with Equation 3:

$$g = \frac{180 * e * w}{π * D} \qquad ( 3 )$$

For “pixelwise” neighborhood brightness matching, i.e., when a display unit is a pixel, g is generally calculated using Equation 3. Thus, when a display unit is a pixel with w=1.6 mm and D=9000 mm, g=0.1% per pixel. Given a tile 250 with a width of 320 pixels, a brightness change of as much as 32% can be achieved across a single tile 250 without perceptible nonuniformity to the viewer. Thus pixelwise neighborhood brightness matching can provide significant increases in overall brightness of display screen 260.

In order to effectively implement pixelwise neighborhood brightness matching, in some embodiments of the invention a map of estimated brightness factors for each pixel element 205 of each tile 250 is constructed. In such an embodiment, the brightness of display screen 260 is determined in a factory calibration procedure using a tristimulus colorimeter to determine intra-tile brightness nonuniformity for each tile 250. Ideally, the actual brightness of essentially every pixel element 205 of each tile 250 is measured with the colorimeter in order to exactly map all nonuniformities in brightness of each tile 250. Because such a procedure may be prohibitively time-consuming, in some embodiments a small sample of test regions on a given tile are measured with the colorimeter, and an estimated brightness is calculated for the majority of pixel elements 205 of each tile 250 using bilinear interpolation. At each test region, a small number of pixel elements 205 are set to full white, the colorimeter is positioned in proximity to the region to be tested, and a colorimeter measurement is performed. FIG. 5 is a schematic diagram of a tile 250 with a plurality of colorimeter test regions 255, according to embodiments of the invention. Each test region 255 includes a plurality of pixel elements 205, so that the area tested by the colorimeter is large enough to provide an accurate signal and small enough to prevent stray light from affecting the measurement. In the embodiment illustrated in FIG. 5, nine test regions 255 define the vertices of four rectangular interpolation regions 256 of tile 250, which are used to perform the intra-tile nonuniformity calculation. Bilinear interpolation is performed between the vertices of each rectangular interpolation region 256 to calculate an estimated brightness factor for each pixel element 205 disposed in the rectangular interpolation region 256. Thus, estimated pixel brightness can be calculated for any pixel element 205 of tile 250 by multiplying the estimated brightness factor of the pixel element 205 by the luminance of the tile, which is measured by the internal luminance detector of tile 250.

Given the measured brightness of a low-brightness tile, such as low-brightness tile 251, the estimated brightness factors of the pixel elements 205 in the low-brightness tile, the estimated brightness factors of the pixel elements 205 in an adjacent tile, such as tile 253, and a maximum allowable brightness gradient, g, for display screen 260, the estimated pixel brightness for each pixel of the adjacent tile can be calculated. Thus, the brightness of pixel elements 205 adjacent to a tile with low brightness performance is incremented in brightness on a per-pixel basis from the brightness level of the low brightness tile nearest the low brightness tile to the brightness level of the higher brightness tiles, so the higher brightness pixels of the tile are adjacent to the higher brightness tile. By smoothly incrementing the brightness of such regions in this manner, perceived brightness uniformity is maintained while maximizing the overall brightness of the tiled display device.

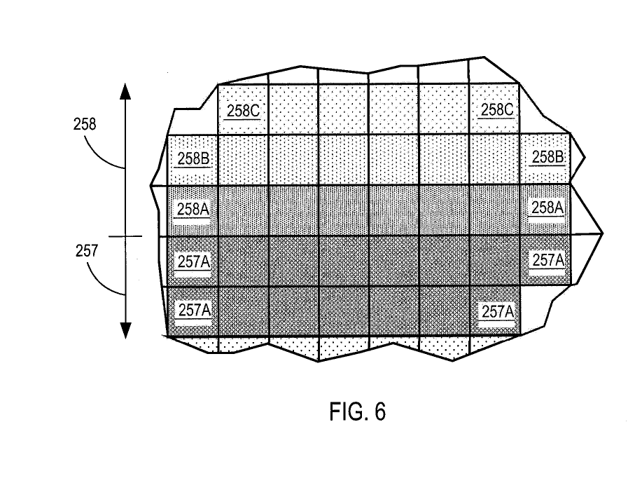

FIG. 6 is a partial schematic diagram illustrating the relative brightness of a region of a low-brightness tile 257 and an adjacent tile 258 that has undergone tilewise neighborhood brightness matching to provide an incremented change in brightness from low-brightness tile 257 to adjacent tile 258. Low-brightness tile 257 and adjacent tile 258 are made up of display units 257A and 258A-C, respectively, where said display units may be individual pixel elements 205 or groups of pixel elements 205. The brightness of the display units 257A and 258A-C in FIG. 6 is represented qualitatively by shading, where heavier shading indicates lower brightness and less shading indicates that a display unit has a greater brightness value assigned thereto. The display units 257A of low-brightness tile 257 are all substantially at a uniform, low brightness level, as indicated by the darker shading. The display units 258A-C of adjacent tile 258 have progressively higher brightness levels, was shown. Thus, display units 258A are adjacent to and incrementally brighter than display units 257A. Similarly, display units 258B are adjacent to and incrementally brighter than display units 258A, and display units 258C are adjacent to and incrementally brighter than display units 258B. Additional rows of display units (not shown) may be incremented to still higher brightness levels, until the brightness level of adjacent tile 258 is achieved.

In order to preserve uniform gamma correction across display screen 260, input for each pixel element 205 should be manipulated with regard to gamma correction on a per pixel basis when pixelwise neighborhood brightness matching is performed. Thus, in some embodiments of the invention, each incoming pixel value of an image is gamma corrected normally, then the pixel value is dimmed as a function of g (as calculated using Equation 3), then gamma correction is re-applied to the pixel value before displaying the image. In this way uniform gamma is maintained even though dimming across display screen 260 varies from pixel element to pixel element. The gamma correction and dimming calculations for each pixel element 205 in a tile 250 may be computed by display processor and controller 190, central controller 280, or a combination of both.

In some embodiments, a display unit may be defined as a group of contiguous pixel elements 205 rather than a single pixel element 205 or an entire tile 250. For example, a display unit may be defined as a 10 by 10 square of pixel elements 205. In such an embodiment, relative threshold width W and the maximum allowable brightness gradient g are calculated based on the distance between two display units w, which is a function of display unit size. Such an embodiment may be a useful compromise between the computationally intensive method of pixelwise neighborhood brightness matching and the less helpful method of tilewise neighborhood brightness matching.

In some embodiments, the display unit may be rectangular in shape, rather than square. In such embodiments, the maximum allowable brightness gradient g will have a different value in the horizontal and in the vertical directions, since the distance between two display units w has a different horizontal and vertical value when the display unit is rectangular.

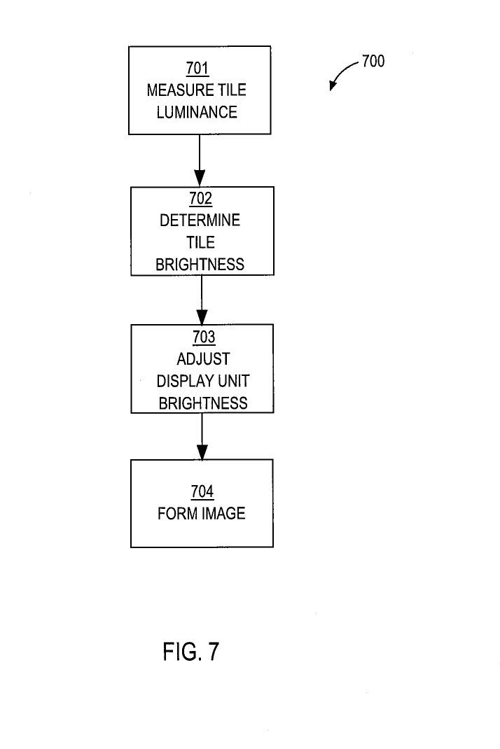

FIG. 7 is a flow chart that summarizes, in a stepwise fashion, a method 700 for performing neighborhood brightness matching in a tiled display system, according to embodiments of the invention. By way of illustration, method 700 is described in terms of an LPD-based tiled display device substantially similar in organization and operation to tiled display system 200 in FIG. 1. However, other electronic tiled display systems may also benefit from the use of method 700. Prior to the first step of method 700, for each tile 250, a map of estimated brightness factors for each pixel element 205 contained therein is constructed. To construct such a map, a tristimulus colorimeter may be used to measure actual brightness of each tile of tiled display system 200 at a plurality of selected points, where said points are positioned to define one or more rectangular interpolation regions 256. The pixel level map of estimated brightness factors for each tile 250 may be stored in a suitably configured memory module in either display processor and controller 190, central controller 280, or both.

In step 701, the luminance of a first tile 250 is measured by detector assembly 180 and communicated to central controller 280 via luminance data 281. Step 701 is then repeated for all other tiles 250 in tiled display system 200. In some embodiments, the luminance of a tile is determined by measuring a reference luminance Lᵣ and a reference power Pᵣ, which are measured in a factory calibration procedure, and the current luminance can be estimated based on measured current power P_{c} for the tile. Specifically, reference luminance Lᵣ of the tile may be measured using a colorimeter in a manner similar to the colorimeter measurements of test regions 255 in FIG. 5. Actual power of the tile can then be measured and actual luminance of the tile may be estimated as =Lᵣ*(P_{c}/Pᵣ). In other embodiments, the luminance of first tile 250 may be estimated based on the output intensity of each of the lasers of the tile 250, which can be determined by detector assembly 180 described above in conjunction with FIG. 2.

In step 702, central controller 280 determines whether the first tile 250 is a low-brightness tile. In one embodiment, a tile is defined as a low-brightness tile if the brightness of said tile is less than any of its neighboring tiles by more than g %. Step 702 is then repeated for all other tiles 250 in tiled display system 200.

In step 703, if the first tile 250 is considered to be a low-brightness tile, central controller 280 adjusts the brightness of display units adjacent to the first tile 250, so that neighborhood brightness of tiled display system 200 is incremented through one or more groups of display units from the brightness level of the first tile 250 to the brightness level of surrounding higher brightness tiles. Specifically, a first group of display units, i.e., the display units adjacent to the low-brightness tile, may undergo a first reduction in brightness so that the first group is imperceptibly brighter than the low-brightness tile. A second group of display units, i.e., the display units adjacent to the first group of display units, may undergo a second reduction in brightness so that the second group is imperceptibly brighter than the first group. Such an incremental increase in brightness of multiple groups of display units continues until the brightness of higher brightness tiles is reached. Step 703 is then repeated for any other tiles 250 that are determined to be low-brightness tiles in step 702.

A display unit of step 703 may be a single pixel element 205, an entire tile 250, or a group of contiguous pixel elements 205, such as a square or rectangle. When a display unit is defined as less than a complete tile 250, the pixel level map of estimated brightness factors is consulted for the low-brightness tile and for the appropriate display units, so that neighborhood brightness matching takes place on the pixel level. The adjustment in brightness of the display units is a function of the maximum allowable brightness gradient g, which is calculated using either Equation 2 or 3. In some embodiments, a display unit is considered to be adjacent to the low-brightness tile or other display unit when the display unit shares a side therewith. In some embodiments, a display unit is considered to be adjacent to the low-brightness tile or other display unit when the display unit shares a side or a common corner therewith.

In step 704, an image is formed by tiled display system 200. For the display units used to increment brightness in the neighborhood of the low-brightness tile, the adjusted brightness values determined in step 703 are used.

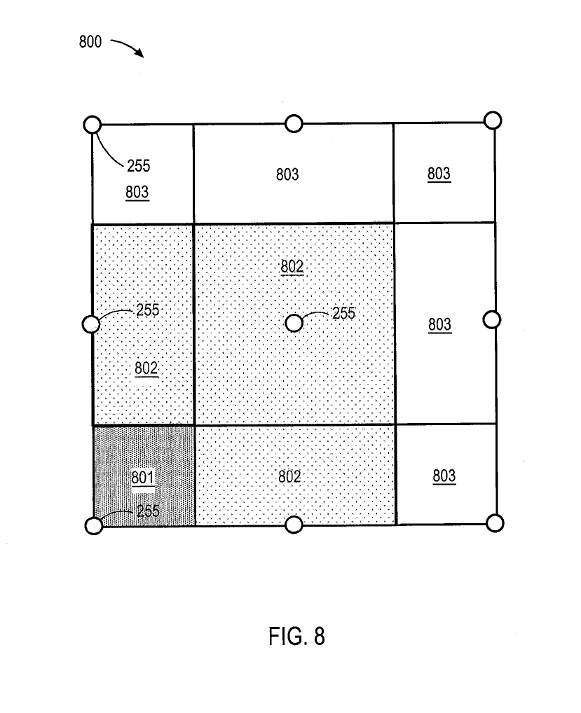

In some embodiments, neighborhood brightness matching may be used to increment brightness surrounding dim regions within a tile. In such an embodiment, each region within a tile may be determined to have dimmed over time by estimating the current luminance of a pre-defined region within the tile and comparing the current luminance of the region with the initial luminance of that region. Given a plurality of test regions, such as the nine test regions 255 illustrated in FIG. 5, total laser power measurements may be taken in conjunction with the colorimeter measurements described above in conjunction with FIG. 5. During said colorimeter measurements, which measure colorimeter luminance L_{c} for each test region 255, a virgin power P, is also measured for each test region 255. The current luminance, L, of a region is defined by Equation 4:

$${L}_{i} = {L}_{ci} * \frac{{P}_{e}}{{P}_{v}} \qquad ( 4 )$$

where i is the region index number, Pc is the current laser power for the tile while test region i is being illuminated, and Pv is the laser power recorded while test region i was being illuminated during the factory colorimeter test. Thus, by illuminating each of the test regions 255 and measuring the current laser power Pc, the current luminance L_{c} can be estimated for each of regions 255. When one or more of regions 255 are determined to be dimmer than the neighboring test regions, the surrounding portion of the tile can be dimmed accordingly to increment neighborhood brightness matching. FIG. 8 illustrates a tile 800 having a plurality of display units 801. The current luminance of each of display units 801, 802, and 803 can be estimated by illuminating the associated test region 255 and measuring the current laser power Pc. In FIG. 8, a dim display unit 801 has been detected using such a procedure, and adjacent display units 802 have been dimmed accordingly to improve brightness uniformity with tile 800, using display units 801-803 to compute maximum allowable brightness gradient, g, and to implement neighborhood brightness matching.

In sum, embodiments of the invention contemplate systems and methods for neighborhood brightness matching between the individual tiles of a tiled display system for improved uniformity and overall brightness of images produced by the display system. By incrementing brightness from the brightness level of low brightness tiles to the brightness level of the higher brightness tiles in a manner that does not exceed a maximum allowable brightness gradient, a tiled display system may provide a seamless array of tiles despite significant brightness variation between the tiles. In addition, the overall brightness of a tiled display is maximized without sacrificing perceived brightness uniformity.

While the foregoing is directed to embodiments of the present invention, other and further embodiments of the invention may be devised without departing from the basic scope thereof, and the scope thereof is determined by the claims that follow.

I claim:

1. A tiled display system comprising:
a first display tile having a luminance detector;
a second display tile adjacent to the first display tile; and
a control unit configured to receive luminance information from the luminance detector and, when the luminance information indicates that a brightness level of the first display tile is below a threshold level, determine a new brightness setting for the second display tile that correlates to a new brightness level that is greater than the brightness level of the first display tile.

2. The system of claim 1, wherein the new brightness setting for the second display tile correlates to a new brightness level that is greater than the brightness level of the first display tile but no more than an allowable brightness gradient between the first and second display tiles.

3. The system of claim 2, wherein the threshold level is defined by a maximum allowable brightness gradient between the brightness level of the first display tile and the brightness level of the second display tile.

4. The system of claim 2, wherein the threshold level is a predefined system-wide brightness level.

5. The system of claim 1, further comprising:
a third display tile adjacent to the second display tile on the other side of the first display tile,
wherein the control unit is further configured to determine a new brightness setting for the third display tile when a current brightness level of the third display tile exceeds an allowable brightness gradient between the second and third display tiles.

6. The system of claim 1, wherein the first and second display tiles are each a laser phosphor display device.

7. A tiled display system comprising:
a first display tile;
a second display tile adjacent to the first display tile; and
a control unit configured to control brightness levels of pixels of the second display tile based on their proximity to the first display tile in response to a threshold decrease in a brightness level of the first display tile.

8. The system of claim 7, wherein the control unit is configured to lower the brightness levels of the pixels of the second display tile that are adjacent to the first display tile by a greater factor than other pixels of the second display tile.

9. The system of claim 7, wherein the control unit is configured to lower the brightness levels of a first group of pixels of the second display tile by a first factor and the brightness levels of a second group of pixels of the second display tile by a second factor, the first factor being greater than the second factor.

10. The system of claim 9, wherein the first group of pixels includes pixels that are adjacent to the first display tile and pixels that are not adjacent to the first display tile, and the second group of pixels does not include any pixels that are adjacent to the first display tile.

11. The system of claim 9, wherein the first group of pixels includes pixels that are adjacent to the first display tile and do not include any pixels that are not adjacent to the first display tile, and the second group of pixels do not include any pixels that are adjacent to the first display tile.

12. The system of claim 7, wherein the control unit is configured to control the brightness levels of pixels of the second display tile such that the brightness levels of at least the pixels that are adjacent to the first display tile are lowered.

13. The system of claim 7, wherein the control unit is configured to control the brightness levels of pixels of the second display tile in such a manner that a gradient of the increase in the brightness levels of a line of pixels extending away from the first display tile is no greater than a maximum allowable brightness gradient for the second display tile.

14. A method of controlling brightness levels of a tiled display system that includes a first display tile and a second display tile that is adjacent to the first display tile, comprising:
measuring a luminance level of the first display tile;
determining that the brightness level of the first display tile is below a threshold level; and
adjusting a brightness level of the second display tile in response to said determining.

15. The method of claim 14, wherein an overall brightness level of the second display tile is adjusted.

16. The method of claim 14, wherein a brightness level of only a portion of the second display tile is adjusted.

17. The method of claim 16, wherein said portion includes pixels of the second display tile that are adjacent to the first display tile.

18. The method of claim 14, wherein the tiled display system further includes a third display tile that is adjacent to the first display tile and shares a common corner with the second display tile, and further comprising:
adjusting a brightness level of the third display tile in response to said determining.

19. The method of claim 18, wherein the brightness levels of the second display tile and the third display tile are decreased by different factors.

20. The method of claim 18, wherein the brightness levels of the second display tile and the third display tile are decreased by no more than a maximum allowable brightness gradient between the second and the third display tiles.

21. A computer-readable storage medium comprising instructions to be executed by a computing device to cause the computing device to carry out the steps of:
receiving a luminance level of a first display tile;
determining that the brightness level of the first display tile is below a threshold level; and
reducing a brightness level of a second display tile that is adjacent to the first display tile in response to said determining,
wherein the brightness level of the second display tile is reduced and a new brightness level of the second display tile after the reduction is greater than the brightness level of the first display tile.

22. The computer-readable storage medium of claim 21, wherein the threshold level is defined by a maximum allowable brightness gradient between the brightness level of the first display tile and the brightness level of the second display tile.

23. The computer-readable storage medium of claim 21, further comprising instructions to be executed by the computing device to cause the computing device to carry out the steps of:
adjusting a brightness level of a third display tile that is adjacent to the first display tile and shares a common corner with the second display tile, in response to said determining,
wherein the brightness level of the third display tile is reduced and a new brightness level of the third display tile after the reduction is greater than the brightness level of the first display tile.

24. The computer-readable storage medium of claim 23, wherein the reduction factor for the second display tile is equal to the reduction factor for the third display tile.

25. The computer-readable storage medium of claim 23, wherein the reduction factor for the second display tile is not equal to the reduction factor for the third display tile.
